(19) United States
(12) Patent Application Publication
(10) Pub. No.: US 2012/0118532 A1
(43) Pub. Date: May 17, 2012

(54) Flexible Attachment System for a Coil Heat Exchanger

(75) Inventors: Chris Jentzsch, Snellville, GA (US); Tom Pethtel, Marietta, OH (US); Chris Mimbs, Stone Mountain, GA (US)

(73) Assignee: LENNOX INTERNATIONAL, INC., Richardson, TX (US)

(21) Appl. No.: 12/947,983

(22) Filed: Nov. 17, 2010

(51) Int. Cl. F28F 9/013; B23P 11/00

(52) U.S. Cl. 165/67; 29/525.01

(57) ABSTRACT

The present application provides an attachment system for mounting a microchannel coil to a support structure. The attachment system may include a bracket fixedly attached to the microchannel coil, a grommet positioned about the bracket, and a fastener extending through the grommet, the bracket, and the support structure so as to attach the microchannel coil thereto. The grommet may include a vibrationally isolating material so as to isolate the microchannel coil from the support structure.

### TECHNICAL FIELD

The present application relates generally to air conditioning and refrigeration systems and more particularly relates to a flexible attachment system for a microchannel coil heat exchanger or a condenser coil for use in condenser assemblies and the like so as to provide flexible support thereto.

### BACKGROUND OF THE INVENTION

Modern air conditioning and refrigeration systems provide cooling, ventilation, and humidity control for all or part of an enclosure such as a building, a cooler, and the like. Generally described, the refrigeration cycle includes four basic stages to provide cooling. First, a vapor refrigerant is compressed within a compressor at high pressure and heated to a high temperature. Second, the compressed vapor is cooled within a condenser by heat exchange with ambient air drawn or blown across a condenser coil by a fan and the like. Third, the liquid refrigerant is passed through an expansion device that reduces both the pressure and the temperature of the liquid refrigerant. The liquid refrigerant is then pumped within the enclosure to an evaporator. The liquid refrigerant absorbs heat from the surroundings in an evaporator coil as the liquid refrigerant evaporates to a vapor. Finally, the vapor is returned to the compressor and the cycle repeats. Various alternatives on this basic refrigeration cycle are known and also may be used herein.

Traditionally, the heat exchangers used within the condenser and the evaporator have been common copper tube and fin designs. These heat exchanger designs often were simply increased in size as cooling demands increased. Changes in the nature of the refrigerants permitted to be used, however, have resulted in refrigerants with distinct and sometimes insufficient heat transfer characteristics. As a result, further increases in the size and weight of traditional heat exchangers also have been limited within reasonable cost ranges.

As opposed to copper tube and fin designs, recent heat exchanger designs have focused on the use of aluminum microchannel coils. Microchannel coils generally include multiple flat tubes with small channels therein for the flow of refrigerant, I-Heat transfer is then maximized by the insertion of angled and/or louvered fins in between the flat tubes. The flat tubes are then joined with a number of manifolds. Compared to known copper tube and fin designs, the air passing over the microchannel coil designs has a longer dwell time so as to increase the efficiency and the rate of heat transfer. The increase in heat exchanger effectiveness also allows the microchannel coil heat exchangers to be smaller while having the same or improved performance and the same volume as a conventional heat exchanger. Microchannel coils thus provide improved heat transfer properties with a smaller size and weight, provide improved durability and serviceability, improved corrosion protection, and also may reduce the required refrigerant charge by up to about fifty percent (50%).

Both copper fin and tube heat exchangers and aluminum microchannel coil heat exchangers generally are firmly attached to the condenser or the evaporator as an integral portion of the overall structure. Traditional copper fin and tube heat exchangers generally had the ability to flex somewhat during changes in temperature and the resultant expansion and contraction associated therewith. Aluminum microchannel coil heat exchangers, however, generally have somewhat less of an ability to flex, expand, and contract. Moreover, the entire condenser and/or evaporator assembly generally must be disassembled in order to access and/or replace the microchannel coils and other components.

There is therefore a desire for an improved microchannel coil attachment system. Such an improved microchannel coil attachment system should provide the ability for sufficient relative expansion and contraction without causing harm to the overall structure. Moreover, the microchannel coil attachment system may largely isolate the microchannel coil from vibrations from the overall cooling system. The microchannel coil attachment system also should provide ease of installation and ease of access thereto.

### SUMMARY OF THE INVENTION

The present application thus provides an attachment system for mounting a microchannel coil to a support structure. The attachment system may include a bracket fixedly attached to the microchannel coil, a grommet positioned about the bracket, and a fastener extending through the grommet, the bracket, and the support structure so as to attach the microchannel coil thereto. The grommet may include a vibrationally isolating material so as to isolate the microchannel coil from the support structure.

The present application further provides for a method of attaching an aluminum coil to a steel support structure. The method described herein may include the steps of fixedly attaching one or more aluminum brackets to the aluminum coil, positioning a rubber grommet about each of the aluminum brackets, and positioning a fastener through each of the rubber grommets, each of the aluminum brackets, and the steel support structure such that the rubber grommets vibrationally isolate the aluminum coil from the steel support structure.

The present application further provides a condenser. The condenser may include a microchannel coil, a support structure for the microchannel coil, a bracket fixedly attached to the microchannel coil, a grommet positioned about the bracket, and a fastener extending through the grommet, the bracket, and the support structure so as to attach the microchannel coil thereto.

These and other features and improvements of the present application will become apparent to one of ordinary skill in the art upon review of the following detailed description when taken in conjunction with the several drawings and the appended claims.

### BRIEF DESCRIPTION OF THE DRAWINGS

FIG. 1 is a front perspective view of a microchannel coil as may be used herein.

FIG. 2 is a front plan view of the microchannel coil of FIG. 1.

FIG. 3 is a side plan view of the microchannel coil of FIG. 1.

FIG. 4 is a top plan view of a microchannel coil of FIG. 1.

FIG. 5 is an exploded perspective view of an attachment system as may be described herein with a microchannel coil and a fan cabinet.

FIG. 6 is an exploded side plan view of the attachment system as may be described herein with the microchannel coil and the fan panel.

FIG. 7 is a side plan view of the attachment system as may be described herein with the microchannel coil attached to the fan panel cabinet.

FIG. 8 is close up view of the attachment system of FIG. 7.

FIG. 9 is a front plan view of an attachment bracket that may be used with the attachment system as described herein.

FIG. 10 is a perspective view of a grommet that may be used with the attachment system as may be described herein.

FIG. 10A is a perspective view of a grommet that may be used with the attachment system as may be described herein.

FIG. 11 is a perspective view of a shoulder screw that may be used with the attachment system as may be described herein.

FIG. 12 is an exploded perspective view of an assembled fan panel cabinet positioned within a condenser.

### DETAILED DESCRIPTION

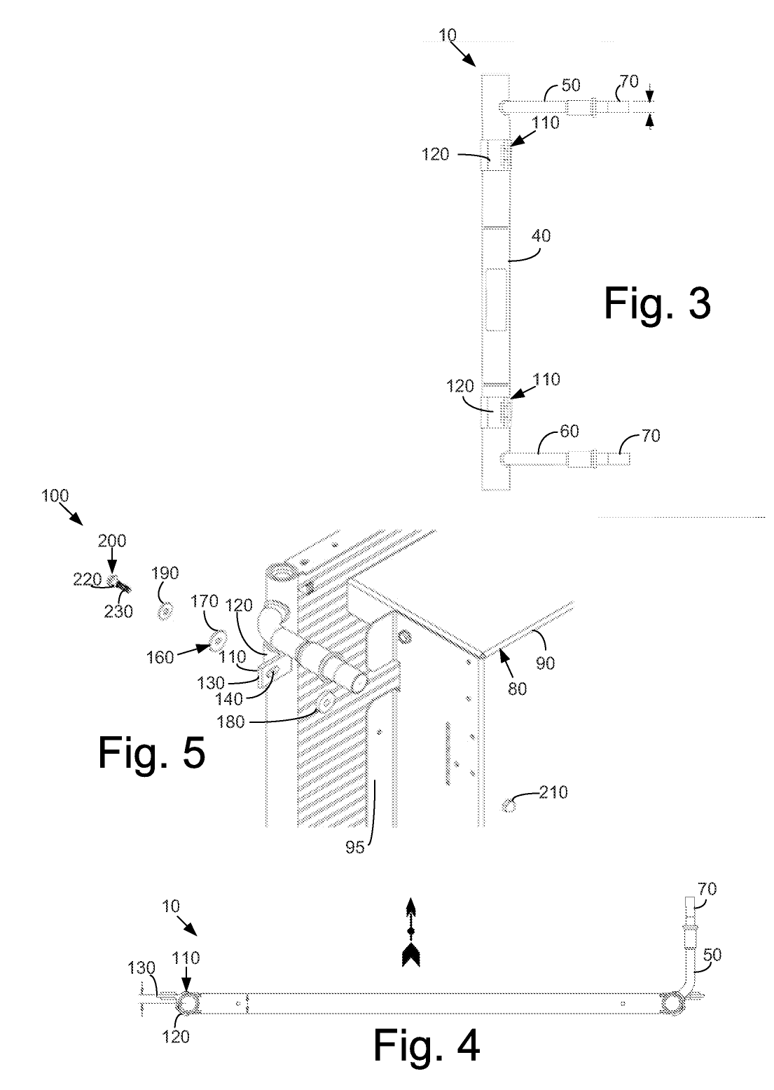

Referring now to the drawings, in which like numerals refer to like elements throughout the several views, FIGS. 1 through 4 show a known microchannel coil 10 similar to that described above. Specifically, the microchannel coil 10 may include a number of microchannel tubes 20 with a number of microchannels therein. The microchannel tubes 20 generally are elongated and substantially flat. Each microchannel tube 20 may have any number of microchannels therein. A refrigerant flows through the microchannels in various directions.

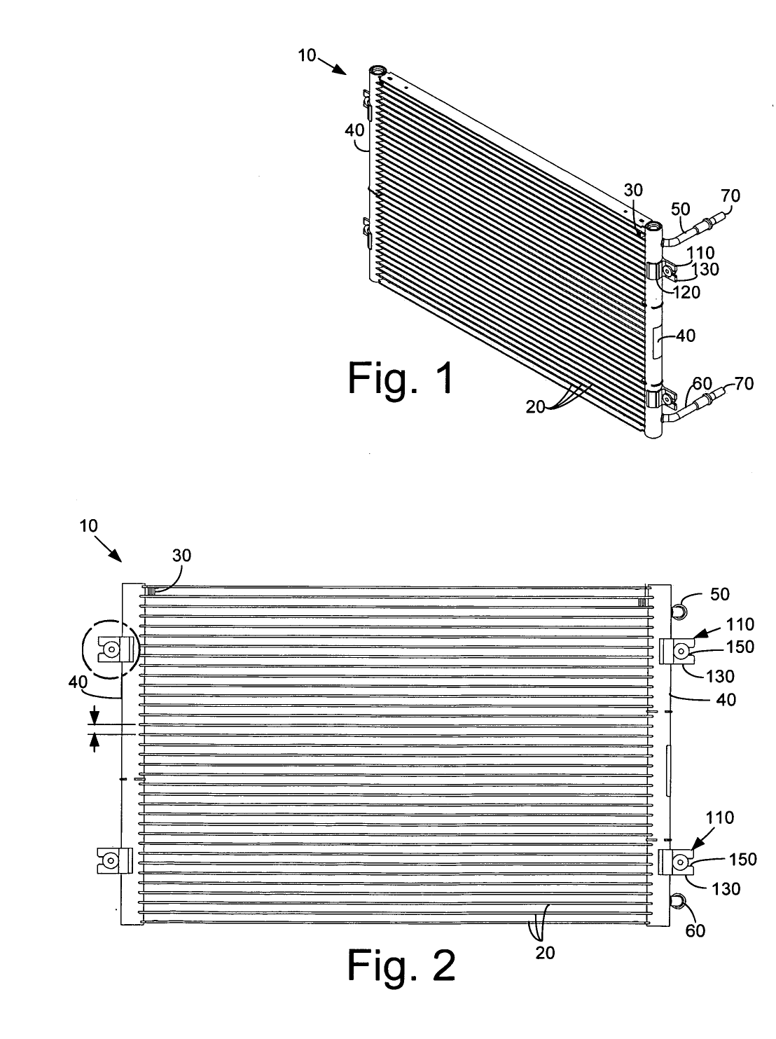

Each of the microchannel tubes 20 may have a number of fins 30 positioned thereon (only a few are shown in FIGS. 1 and 2). The fins 30 may be straight or angled. The combination of a number of small tubes 20 with the associated high density fins 30 thus provides more surface area per unit volume as compared to known copper fin and tube designs for improved heat transfer. The fins 30 also may be louvered over the microchannel tubes 20 for an even further increase in surface area. Any number of fins 30 may be used. The microchannel tubes 20 generally extend from one or more manifolds 40. The manifolds 40 may be in communication with the overall air-conditioning or refrigeration system as is described above. The overall microchannel coil and the components thereof generally are made out of extruded aluminum and the like.

Examples of known microchannel coils 10 include those offered by Hussmann Corporation of Bridgeton, Mo.; Modine Manufacturing Company of Racine, Wis.; Carrier Commercial Refrigeration, Inc. of Charlotte, N.C.; Delphi of Troy, Mich.; Danfoss of Denmark; and from other sources. The microchannel coils 10 generally may be provided in standard or predetermined shapes and sizes. Any number of microchannel coils 10 may be used together, either in parallel, series, or combinations thereof. Various types of refrigerants and other thermal mediums may be used herein.

Each microchannel coil 10 also may include an inlet 50 and an outlet 60 in communication with the manifold 40. Both the inlet 50 and the outlet 60 may end in a transition tube 70. Although the inlet 50 and the outlet 60 may be made out of aluminum, the transition tube 70 may be made from copper plated stainless steel. The transition tubes 70 of the inlet 50 and the outlet 60 may be brazed or welded to the other components of an overall refrigeration system. Because the copper and the aluminum do not come into contact with one another, there is no chance for the galvanic corrosion and the like. Other types of fluid type connections and/or quick release couplings may be used herein.

The microchannel coil 10 generally may be positioned within a steel sheet metal support structure 80. As described above, the aluminum and the steel sheet metal generally have differing rates of thermal contraction and expansion such that fixed attachments may be problematic. In this example, the steel sheet metal support structure 80 may be a fan panel cabinet 90 with a number of mounting apertures 95 therein, although the microchannel coil 10 may be attached to other types of steel sheet metal support structures 80 and other types of support structures. Other types of materials, such as plastics, composites, and the like may be used herein.

FIGS. 5-8 show a microchannel coil attachment system 100 as may be described herein. The microchannel coil attachment system 100 attaches the microchannel coil 10 to the support structure 80. The microchannel coil attachment system 100 includes a number of brackets 110. The brackets 110 may be mounted onto the manifolds 40 of the microchannel coil 10. The brackets 110 may be brazed, welded, or otherwise attached to the manifolds 40. The brackets 110 may be made out of aluminum and the like similar to that of the manifolds 40.

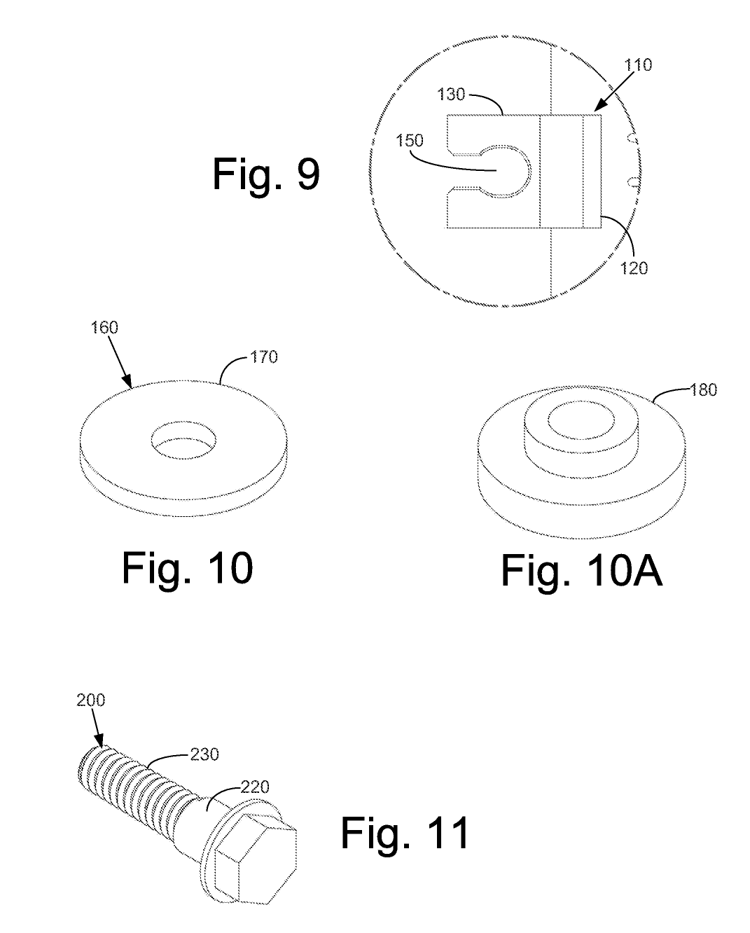

The brackets 110 each may include a substantially C-shaped attachment clip 120 for mounting on the manifold 40. A mounting flange 130 may extend from the attachment clip 120. As is shown in, for example, FIG. 5 the mounting flange 130 may have a substantially oval shaped aperture 140 therein. Alternatively, as is shown in FIG. 2 and FIG. 9, the mounting flange 130 also may have an open, substantially U-shaped aperture 150. Other shapes and configurations may be used herein, Any number of brackets 110 may be used herein.

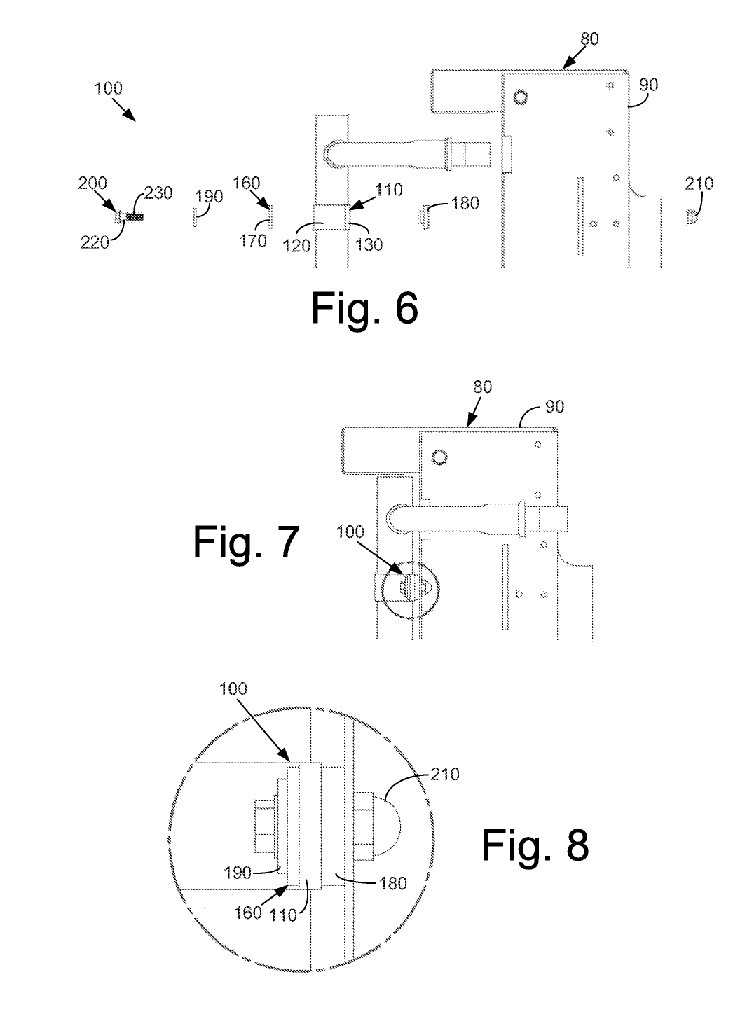

The microchannel coil attachment system 100 also may include a grommet 160. The grommet 160 may extend through the aperture 140, 150 of the mounting flange 130 of the brackets 110. As is shown in, for example, FIGS. 6, 10, and 10A, the grommet 160 may be a two piece grommet 160 with a washer 170 and a stem bushing 180. A unitary construction also may be used with, for example, the U-shaped aperture 150 of the mounting flange 130. The grommet 160 preferably may be made from a vibrationally isolating material such as Neoprene (Neoprene is a brand of polychloroprene offered by E. I. DuPont de Nemours & Company of Wilmington, Del.). The grommet 160 may have a stiffness of about 60-80 durometer or so. Other types of rubber and/or other types of substantially flexible materials and the like with good absorption and dampening qualities may be used herein. The material preferably also may be suited for an outdoor environment so as to accommodate large temperature variations, sunlight, contaminates, etc.

The microchannel coil attachment system 100 also may include a flat washer 190. The flat washer 190 may be positioned behind the washer 170 of the grommet 160. The flat washer 190 provides a large bearing surface on the grommet 160. The flat washer 190 may be made out of steel and other types of substantially rigid materials.

The microchannel coil attachment system 100 also may include a fastener such as a shoulder screw 200 with a mating cap nut 210. The shoulder screw 200 may include a shoulder portion 220 and a threaded portion 230. The threaded portion may include a sheet metal thread, a machine thread, and the like. The shoulder portion 220 provides optimal spacing in that the shoulder portion 220 stops the shoulder screw 200 from being over tightened. Over tightening may compress the grommet 160 to the point it would lose its vibration isolation capability. The shoulder portion 220 also makes for easy production in that no controls are needed to maintain the optimum distance. Other configurations may be used herein.

In use, the microchannel coil attachment system 100 attaches the microchannel coil 10 to the support structure 80. As is shown herein, the support structure 80 may be a fan panel cabinet 90 but any type of support structure may be used herein. Once the brackets 110 are attached to the manifolds 40 of the microchannel coil 10, the microchannel coil 10 may be positioned about the support structure 80. The grommet 160 in the one or the two piece construction then may be positioned about the aperture 140, 150 of the mounting flange 130. The shoulder screw 200 may be passed through the flat washer 190, the grommet 160, the mounting aperture 95 of the support structure 80, and fixed into place via the cap nut 210. This process then may be repeated for each mounting flange 130. Other configurations and other components also may be used herein.

The microchannel coil attachment system 100 thus limits overall system vibrations from the fan, the compressor, and the like from communication with the microchannel coil 10. Specifically, the rubber grommet 160 provides for absorption and dampening of vibrations that may be transmitted to the microchannel coil 210. The grommet 160 provides vibration isolation to the microchannel coil 10 so as to limit fatigue of the aluminum material therein. This flexible attachment system 100 thus is compared to current structures in which the condenser coils may be rigidly mounted to the support structure 80.

The microchannel coil attachment system 100 also accommodates the thermal expansion/contraction rate of the microchannel coil 10 as compared to the expansion/contraction rate of the support structure 80. The apertures 140, 150 of the mounting flange 130 are enlarged so as to capture the grommet 160, but allow it to move therein. Without such flexibility, the differing expansion and contraction rates may create undesirable stress conditions on the microchannel coil 10.

Similarly, the microchannel coil attachment system 100 also provides easy mounting and alignment. Due to production capabilities and tolerance stack up, the mounting flanges 130 attached to the microchannel coil 10 may not always align with the mounting apertures 95 of the support structure 80. The combination of the grommets 160 and the enlarged apertures 140, 150 thus provide for flexibility in any misalignment. The use of the shoulder screw 200 also controls compression of the grommet 160 to avoid over tightening without repeated measurement.

Although the microchannel coil attachment system 100 has been described in the context of the microchannel coil 10, the attachment system 100 may be used in any product in which a microchannel coil is used, in any product in which aluminum tube coils are used, and in any coil where fin length may be large enough to cause issues with thermal expansion. Other advantages and benefits are provided herein with the use of the microchannel coil attachment system 100.

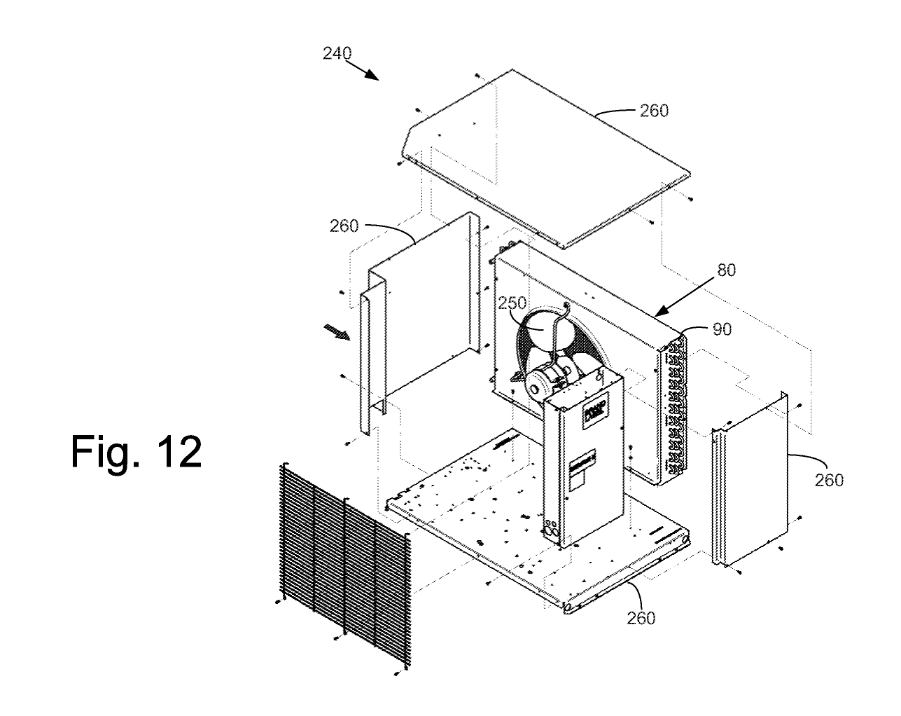

FIG. 12 shows the microchannel coil 10 positioned within the fan panel cabinet 90 as part of an overall condenser unit 240. As is shown, a fan 250 also may be positioned about the fan panel cabinet 90 adjacent to the microchannel coil 10. The fan panel cabinet 90 then may be positioned within a number of sheet metal panels 260. Other components and other types of materials may be used herein. As is described above, the microchannel coil attachment system 100 serves to isolate the microchannel coil 10 from the vibrations produced herein.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. An attachment system for mounting a microchannel coil to a support structure, comprising:
a bracket fixedly attached to the microchannel coil;
a grommet positioned about the bracket; and
a fastener extending through the grommet, the bracket, and the support structure so as to attach the microchannel coil thereto;
wherein the grommet comprises a vibrationally isolating material so as to isolate the microchannel coil from the support structure.

2. The attachment system of claim 1, wherein the microchannel coil comprises a manifold and wherein the bracket is fixedly attached to the manifold.

3. The attachment system of claim 1, wherein the microchannel coil comprises an aluminum, wherein the bracket comprises an aluminum, and wherein the support structure comprises a steel.

4. The attachment system of claim 1, wherein the bracket comprises a mounting flange with an aperture extending therethrough so as to accommodate a relative expansion and contraction of the microchannel coil and the support structure.

5. The attachment system of claim 4, wherein the aperture comprises an oval shape or an open U-shape.

6. The attachment system of claim 1, wherein the bracket comprises an attachment clip.

7. The attachment system of claim 1, wherein the grommet comprises a washer and a stem bushing.

8. The attachment system of claim 1, wherein the grommet comprises a unitary element or a plurality of elements.

9. The attachment system of claim 1, wherein the grommet comprises a polychloroprene or other types of rubber.

10. The attachment system of claim 1, further comprising a metal washer positioned about the grommet.

11. The attachment system of claim 1, wherein the fastener comprises a shoulder portion and a threaded portion.

12. The attachment system of claim 1, further comprising a plurality of brackets, a plurality of grommets, and a plurality of fasteners.

13. A method of attaching an aluminum coil to a steel support structure, comprising:
fixedly attaching one or more aluminum brackets to the aluminum coil;
positioning a rubber grommet about each of the aluminum brackets; and
positioning a fastener through each of the rubber grommets, each of the aluminum brackets, and the steel support structure such that the rubber grommets vibrationally isolate the aluminum coil from the steel support structure.

14. The method of claim 13, further comprising the step of providing the one or more aluminum brackets with an enlarged aperture so as to accommodate the relative expansion and contraction of the aluminum coil and the steel support structure.

15. The method of claim 13, further comprising the step of providing the fastener with a shoulder so as to prevent over tightening of the fastener.

16. A condenser, comprising:
a microchannel coil;
a support structure for the microchannel coil;
a bracket fixedly attached to the microchannel coil;
a grommet positioned about the bracket; and
a fastener extending through the grommet, the bracket, and the support structure so as to attach the microchannel coil thereto.

17. The condenser of claim 16, wherein the microchannel coil comprises an aluminum, wherein the bracket comprises an aluminum, and wherein the support structure comprises a steel.

18. The condenser of claim 16, wherein the bracket comprises a mounting flange with an aperture extending therethrough so as to accommodate a relative expansion and contraction of the microchannel coil and the support structure.

19. The condenser of claim 16, wherein the grommet comprises a washer and a stem bushing.

20. The condenser of claim 16, wherein the grommet comprises a polychloroprene or other types of rubber so as to isolate vibrationally the microchannel coil from the support structure.
